(19) United States
(12) Patent Application Publication
(10) Pub. No.: US 2026/0193028 A1
(43) Pub. Date: Jul. 9, 2026

(54) LID PROTECTION DEVICE OF RESIDENTIAL DUMPSTER, METHODS OF ASSEMBLY AND METHODS OF USE

(71) Applicant: Serio-Us Industries, Inc., Baltimore, MD (US)

(72) Inventors: David L. REEB, Sykesville, MD (US); James L. Martin, II, Gambrills, MD (US)

(21) Appl. No.: 19/434,942

(22) Filed: Dec. 29, 2025

Related U.S. Application Data
(60) Provisional application No. 63/740,054, filed on Dec. 30, 2024.
(60) Provisional application No. 63/798,724, filed on May 2, 2025.

(51) Int. Cl. B65F 1/16

(52) U.S. Cl. CPC B65F 1/1646

(57) ABSTRACT

A residential dumpster comprises a hollow container body member, a lid member and a lid protection device. The container body member has a side wall defining an open top edge. The lid member is pivotally attached to the rear wall of the container body member and is pivotable between an open position and a closed position over the open top edge of the container body member. The lid protection device includes at least one lid protection member fixed to an outer peripheral flange of the lid member or to the container body member adjacent to the open top edge of the container body member. The at least one lid protection member including a front straight plate and an integral curved angle plate.

### CROSS-REFERENCE TO RELATED APPLICATIONS

This application claims the benefit of priority of U.S. Provisional Patent Applications Ser. No. 63/740,054 filed on Dec. 30, 2024, by David L. Reeb and James L. Martin, and Ser. No. 63/798,724 filed on May 2, 2025, by James L. Martin and David L. Reeb, which are hereby incorporated herein by reference in their entirety and to which priority is claimed.

### BACKGROUND OF INVENTION

### 1. Field of the Invention

This invention relates generally to containers and, particularly, to a container for receiving waste or recyclable material. More particularly, the invention relates to reinforcement of a lid of waste containers, and a lid protection device of waste containers, methods of reinforcing waste containers, and methods of using the reinforced containers.

### 2. Description of the Prior Art

Currently, residential trash (or waste) containers, i.e., residential dumpsters or totes, are used to store accumulated household refuse until such household refuse can be collected by garbage trucks or the like. Typically, such residential dumpsters include a lid for concealing the household refuse collected therein, as well as to prevent wild animals from accessing the enclosed household refuse. With some containers, the lid is integrally mounted to a storage bin which contains the collected household refuse. The residential dumpsters are typically made of a plastic material. Such containers may be awkward to use and/or to maintain. Specifically, the plastic residential dumpsters can be knocked over by wind, animals or people and be damaged when the container hits the ground or other obstacles, and can result in spilling the trash. Additionally, due to the elongated nature, a heavy load, such as a bear, sitting on the dumpster when on its side may cause the dumpster to collapse and empty its contents by causing the lid to spring open.

Therefore, there is a need for a plastic residential dumpster reinforced so as to prevent damage of the plastic residential dumpster such as by an accidental knockdown by wind, animals or people.

Known residential dumpsters generally include front, rear and a plurality of side walls extending upwardly from the perimeter of a bottom wall to collectively define an interior. A handle extends from an upper end of the rear wall, such that the residential dumpster can be tipped back onto wheels and pulled by the handle. A lid is hingedly connected to an upper edge of the rear wall.

Rodents, raccoons, bears and other animals often try to gain access to the contents of residential dumpsters. There have been various attempts to provide rodent-resistant and/or animal-resistant lidded dumpsters, but the known dumpsters/lids have been inconvenient for the human users.

Moreover, known garbage cans can be conveniently handled because they can be rolled on their caster wheels when they are tilted about the caster wheels axis, they have the disadvantage that they cannot be nested unless the caster wheels are detached. For this reason the caster wheels cannot be mounted in a manufacturing plant.

### SUMMARY OF THE INVENTION

According to a first aspect of the invention, there is provided a residential dumpster comprises a hollow container body member and a lid member. The hollow container body member has a side wall defining an open top edge. In turn, the side wall includes a front wall, a rear wall opposite the front wall, a right wall connecting the front wall and the rear wall, and a left wall opposite the right wall and connecting the front wall and the rear wall. The lid member is pivotally attached to the rear wall of the container body member and is pivotable between an open position and a closed position over the open top edge of the container body member. The lid member has an outer peripheral flange. The residential dumpster further comprises a lid protection device including at least one lid protection member fixed to the outer peripheral flange of the lid member or to the container body member adjacent to the open top edge of the container body member. The at least one lid protection member includes a front straight plate and an integral curved angle plate.

According to a second aspect of the invention, a method for assembling a residential dumpster is provided. The method for assembling a residential dumpster comprises the step of providing a hollow container body member having a side wall defining an open top edge 13, and a lid member. The side wall includes a front wall, a rear wall opposite the front wall, a right wall connecting the front wall and the rear wall, and a left wall opposite the right wall and connecting the front wall and the rear wall. Then, the lid member is pivotally attached a to the rear wall of the container body member so that the lid member is pivotable between an open position and a closed position of the container body member. The lid member has an outer peripheral flange. Next, a lid protection device is provided, which includes at least one lid protection member. The at least one lid protection member includes a front straight plate and an integral curved angle plate. Subsequently, the at least one lid protection member is non-moveably attached to the outer peripheral flange of the lid member or to the container body member adjacent to the open top edge of the container body member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Other aspects of the invention, including apparatus, devices, systems, converters, processes, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals. In these drawings:

FIG. 1 is a front perspective view of a residential dumpster according to a first exemplary embodiment of the present invention;

FIG. 2 is a rear perspective view of the residential dumpster according to the first exemplary embodiment;

FIG. 3 is a perspective view of the residential dumpster showing a lid protection device for the lid of the residential dumpster according to the first exemplary embodiment;

FIG. 4 is a partial perspective view of the protection device of the lid of the residential dumpster shown in FIG. 3;

FIG. 5 is an enlarged partial perspective view of the lid protection device of the lid of the residential dumpster shown in FIG. 4;

FIG. 6A is a front perspective view showing the lid protection device according to the first exemplary embodiment;

FIG. 6B is a rear perspective view showing the lid protection device according to the first exemplary embodiment;

FIG. 7 is a front perspective view of a residential dumpster with a lid protection device according to a second exemplary embodiment of the present invention;

FIG. 8 is a rear perspective view of the residential dumpster with the lid protection device according to the second exemplary embodiment;

FIG. 9 is a perspective view of the residential dumpster showing the lid protection device according to the second exemplary embodiment without a lid;

FIG. 10 is a perspective view showing the lid protection device and a body reinforcement structure of a hollow body portion according to the second exemplary embodiment;

FIG. 11 is a front perspective view of a residential dumpster with a lid protection device according to a third exemplary embodiment of the present invention;

FIG. 12 is a front perspective view of the residential dumpster if FIG. 11 with an open lid member;

FIG. 13 is a perspective view of nested residential dumpsters according to the third exemplary embodiment;

FIG. 14 is a front perspective view of the lid protection device of the residential dumpster shown in FIG. 12; and

FIG. 15 is a rear perspective view of the lid protection device of the residential dumpster shown in FIG. 12.

### DESCRIPTION OF THE PREFERRED EMBODIMENT

References will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal”, “vertical”, “front”, “rear” or “back”, “upper”, “lower”, “upright”, “side”, “top”, “bottom”, “right”, “left” or the like as well as derivatives thereof (e.g., “horizontally”, “downwardly”, “upwardly”, etc.) designate directions in the drawings to which reference is made and are relative characterizations only based upon the particular position or orientation of a given component as illustrated. These terms shall not be regarded as limiting the invention. The words “downward” and “upward” refer to position in a vertical direction relative to a geometric center of the apparatus of the present invention and designated parts thereof. The terminology includes the words above specifically mentioned, derivatives thereof and words of similar import.

These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. The words “smaller” and “larger” refer to relative size of elements of the apparatus of the present invention and designated portions thereof. Additionally, the word “a” and “an” as used in the claims means “at least one” and the word “two” as used in the claims means “at least two”.

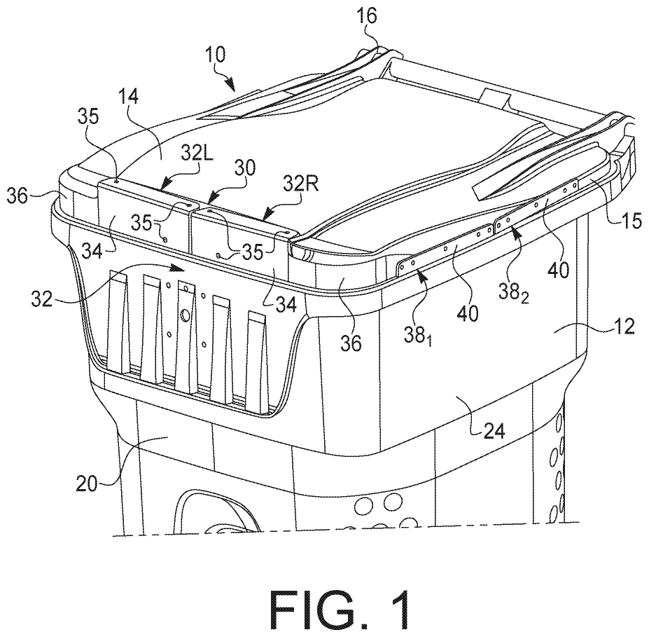

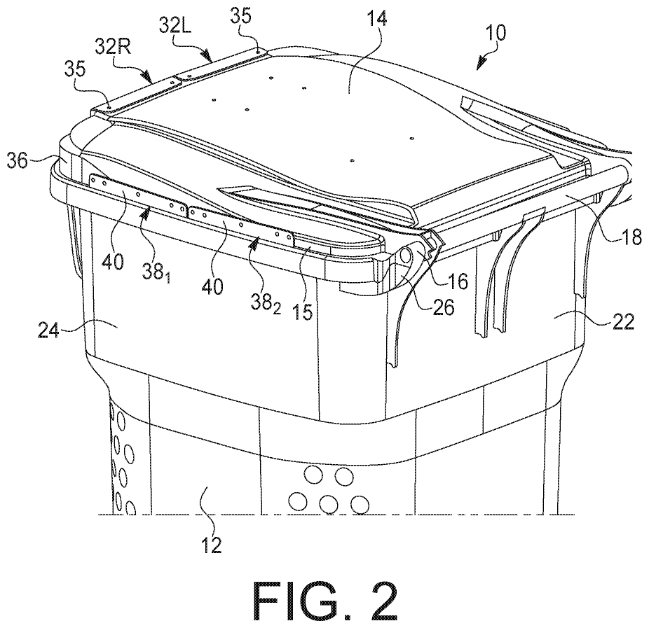

FIGS. 1 and 2 show a residential trash container (or residential dumpster) 10 according to a first exemplary embodiment of the present invention. The residential dumpster 10, such as a roll-out cart, is designed to be resistant to bears and other large and small animals. The residential dumpster 10 comprises a hollow container body member 12 and a lid member 14 that is pivotally attached to a rear side of the container body member 12 by a hinge pin 16.

Both the container body member 12 and the lid member 14 of the residential dumpster 10 are made of suitable plastic material, such as polyethylene, that is tough, light-weight and strong. Metal, such as steel or aluminum alloy, provide a skeletal frame reinforcement structure for dumpster 10. The hollow container body member 12 and the lid member 14 may be made by injection molding or rotational molding. The lid member 14 is pivotally mounted on the hinge pin 16, typically at a rearward portion of the residential dumpster 10, so that when an upward force is applied to a distal end of the lid member 14, the lid member 14 opens by pivoting about the hinge pin 16.

The hollow container body member 12 has a closed bottom and an open top edge fitted to the lid member 14, which can be manipulated between an open position to access the residential trash container 10 and a closed position to close an open top edge 13 of the container body member 12 and restrict access to the residential dumpster 10. The residential dumpster 10 is usually rectangular or cylindrical in shape, however the shape may be dictated by methods of manufacture, economics or aesthetics. It will be appreciated that any other containers with removable or pivotable lids, such as dumpsters, are within the scope of the present invention.

According to the first exemplary embodiment, the hollow container body member 12 of the residential dumpster 10 includes a bottom wall closing the bottom of dumpster 10, a front wall 20, a rear wall 22 and side walls 24 extending upwardly from the bottom wall to define a residential dumpster interior. A handle 18 extends from an upper end of the rear wall 22, such that the residential dumpster 10 can be tipped back onto wheels and pulled by the handle 18. The handle 18, which may be used to pull the residential dumpster 10, is mounted over the hinge pin 16 and secured to handle supports 26, as best shown in FIGS. 1 and 2.

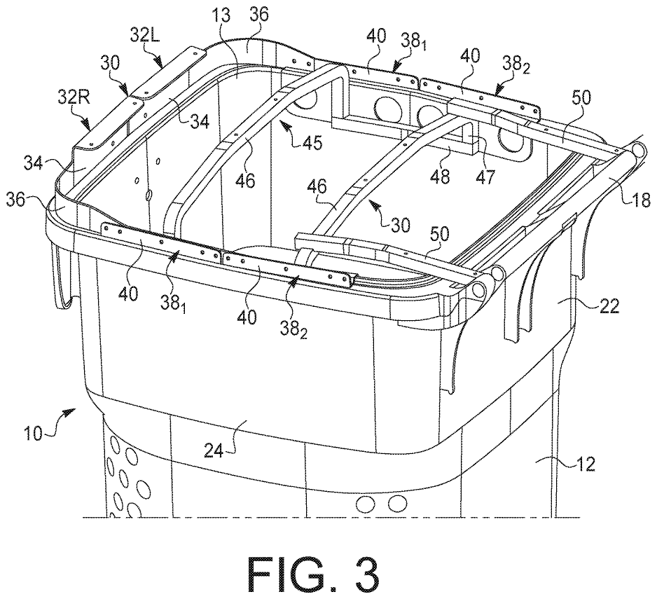

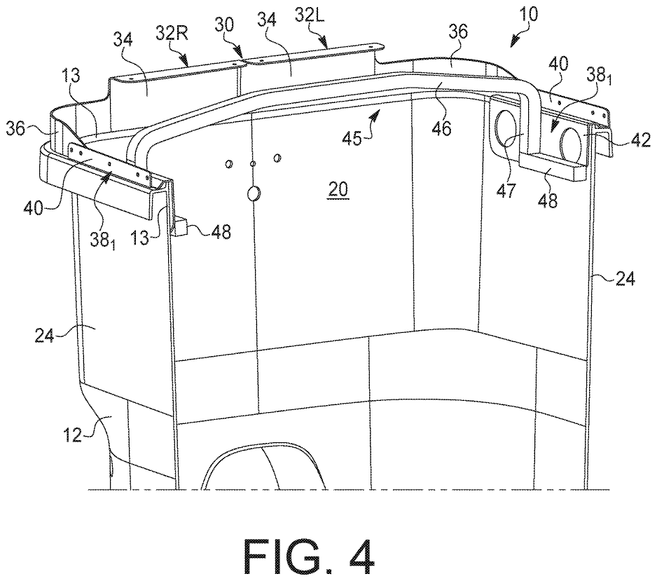

The lid member 14 includes a lid protection (or lid reinforcement) device 30 fixed (i.e., non-moveably attached) to a peripheral flange 15 of the lid member 14. The lid protection device 30 according to the first exemplary embodiment comprises a lid protection (or lid reinforcement) member 32. In turn, the lid protection member 32 includes right and left lid protection members 32R and 32L, respectively, formed separately and spaced from each other, as best shown in FIGS. 1, 3, 4, 6A and 6B. Each of the right and left lid protection members 32R and 32L is a unitary component and comprises an L-shaped front guard plate 34 and an integral curved angle plate 36, as shown in FIGS. 3-6B. Each of the right and left reinforcing members 32R and 32L is non-moveably attached (i.e., fixed) to the peripheral flange 15 of the lid member 14, such as by welding, adhesive bonding riveting or with threaded fasteners, e.g., bolts and nuts. Moreover, each of the right and left reinforcing members 32R and 32L according to the first exemplary embodiment is made of a sheet steel having thickness of about 1 mm according to the first exemplary embodiment. Also, each of the front guard plates 34 includes a front straight plate 34F configured to be secured to and parallel to the peripheral flange 15 of the lid member 14, and a 34H formed orthogonal to the front straight plate 34F, as best shown in FIG. 1-6B.

According to the exemplary embodiment, as shown in FIGS. 1-3, the front guard plate 34 is a non-moveably attached (i.e., fixed) to the top edge the outer peripheral flange 15 of the lid member 14 of the hollow body member 12, such as by welding, adhesive bonding or mechanical fasteners (rivets, bolts and nut connection, threaded fasteners, etc.) extending through holes 35 in the front guard plate 34.

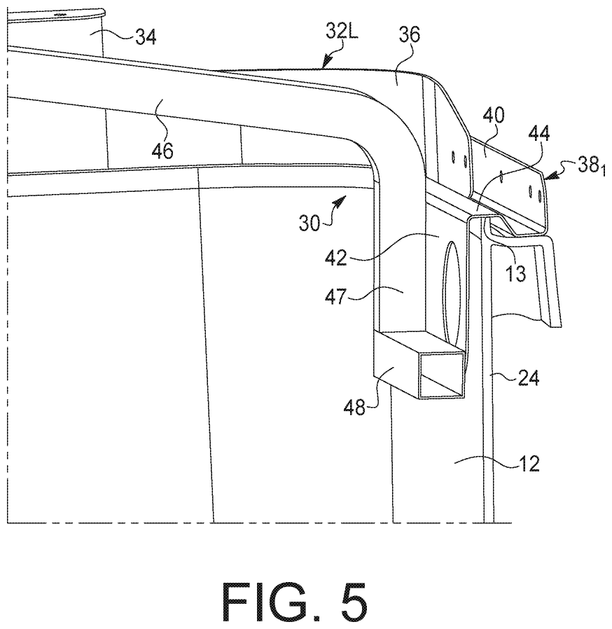

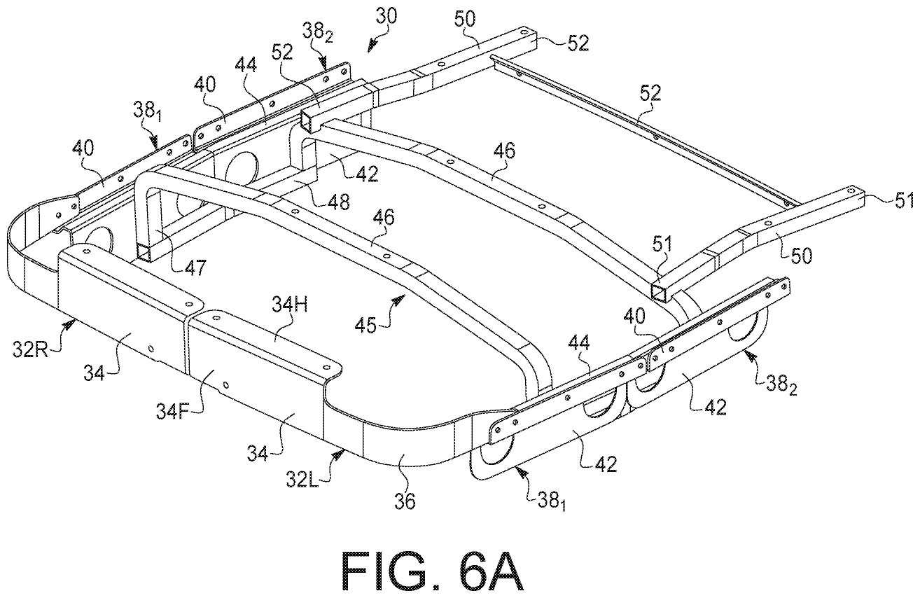

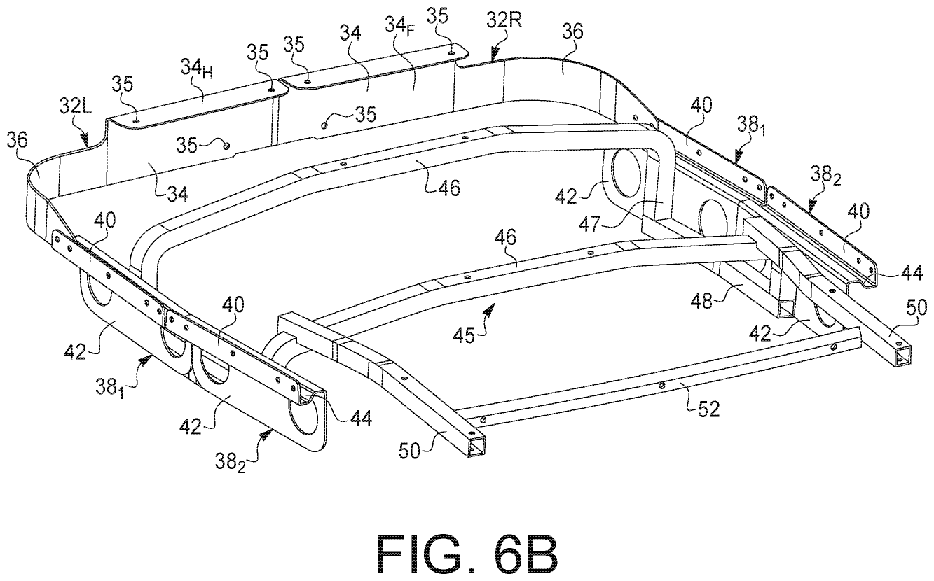

The lid protection device 30 also includes at least one, and preferably two (e.g., first and second), side protection (or reinforcement) members 38₁ and 38₂ mounted to the peripheral flange 15 on each side of the lid member 14, as shown in FIGS. 1-3. Each of the first and second side reinforcing members 38₁ and 38₂ includes an outer plate 40 adjacent to an outer surface of one of the side walls 24 of the hollow container body member 12, an inner plate 42 adjacent to an inner surface of one of the side walls 24 of the hollow container body member 12, and a connecting plate 44 linking the outer and inner plates 40, 42 and supported by the top edge 13 of the hollow container body member 12 when the lid member 14 in the closed position, as best shown in FIGS. 5, 6A and 6B.

Each of the outer plates 40 of the first and second side reinforcing members 38₁ and 38₂ is fixed to the peripheral flange 15 of the lid member 14, such as by welding, riveting or with threaded fasteners, while the front of the first and second side reinforcing members 38₁ and 38₂ (i.e., the first side reinforcing member 38₁) is also fixed to the curved angle plate 36 of the associated one of the right and left reinforcing members 32R and 32L, as best shown in FIGS. 1-3.

The lid protection device 30 also includes a top reinforcing structure 45 mounted to each of the right and left side reinforcing members 38₁ and 38₂, as best shown in FIGS. 3-6B. The top reinforcing structure 45 includes one or more arched transverse lid support members 46, each having opposite transverse ends 47, as best shown in FIGS. 3-6B. Each of the opposite transverse ends 47 of the arched transverse lid support members 46 is fixed to one of the opposite inner plates 42 of the side reinforcing members 38₁ and 38₂. Specifically, each of the opposite transverse ends of the arched transverse lid support members 46 is fixed to one of longitudinally extending opposite support bars 48. In turn, each of the longitudinally extending support bars 48 is fixed to one of the inner plates 42 of the side reinforcing members 38₁ and 38₂, such as by welding. The arched transverse lid support members 46 are shaped complementary to an inner surface of the lid member 14 of the residential dumpster 10. Also, each of the transverse lid support members 46 is non-moveably attached to the lid member 14 such as by welding, adhesive bonding or mechanical fasteners (rivets, bolts and nut connection, etc.).

The top reinforcing structure 45 further includes two or more longitudinal lid support members 50 each having opposite longitudinal ends. One of the opposite longitudinal ends of each of the longitudinal lid support members 50 is fixed to one of the transverse lid support members 46. The top reinforcing structure 45 also includes a transverse reinforcing bar 52 extending between the longitudinal lid support members 50. Each of the opposite ends of the transverse reinforcing bar 52 is fixed (i.e., non-moveably secured) to one of the longitudinal lid support members 50.

The transverse lid support members 46, the longitudinally extending support bars 48, and the transverse reinforcing bar 52 of the top reinforcing structure 45 are made of a thin steel tubing, which preferably is square in cross-section. Each of the transverse lid support members 46 and the transverse reinforcing bar 52 is fixed to an inner surface of the lid member 14, such as by riveting or with threaded fasteners, e.g., bolts and nuts.

As a result of the reinforcement system, should a large weight, such as from a bear or other large animal, rest upon lid member 14, whether while the dumpster is vertical or if horizontal, will not collapse the dumpster 10 or spring open lid member 14 and allow the contents to spill out. Likewise, if the dumpster 10 is tipper over horizontal and the bear or other large animal rests upon it, the lid member 14 will not spring free from the dumpster 10 or collapse and allow access to the interior of the dumpster 10.

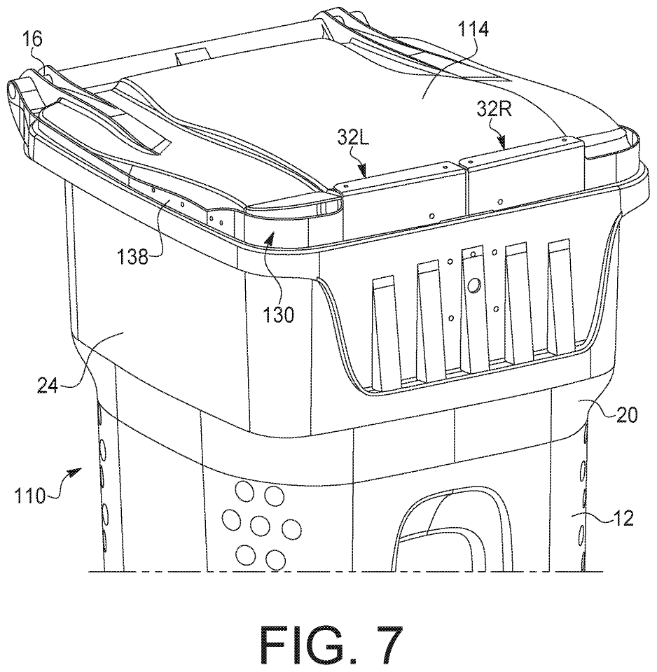

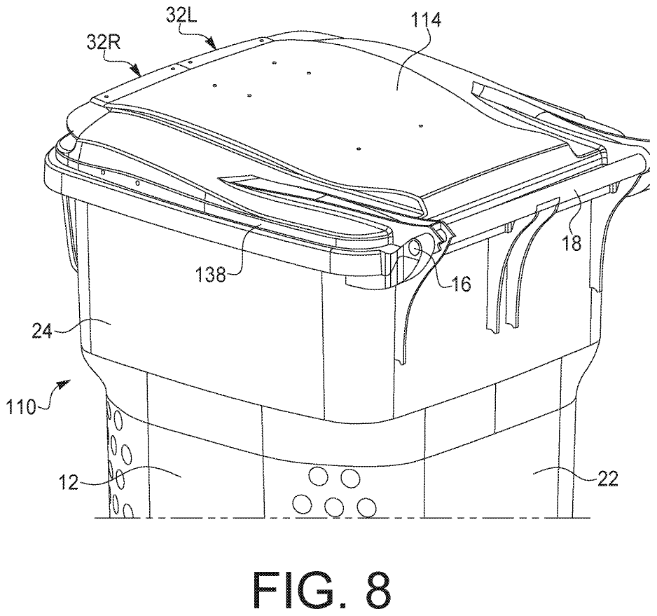

FIGS. 7-9 show a residential trash container (or residential dumpster) 110 according to a second exemplary embodiment. The residential dumpster 110, such as a roll-out cart, is designed to be resistant to bears and other large and small animals. The residential dumpster 110 comprises a hollow body portion 12 and a lid member 114 that is pivotally attached to a rear side of the body portion 12 by a hinge pin 16.

The lid member 114 includes a lid reinforcement structure 130 secured (e.g., non-moveably attached or fixed) to a peripheral flange 15 of the lid member 114. The lid reinforcement structure 130 according to the second exemplary embodiment includes right and left reinforcing members 32R and 32L, respectively, and a peripheral support member 138 made in the form of a split ring. Each of the right and left reinforcing members 32R and 32L is a unitary component and comprises a front guard plate 34 and a curved angle plate 36, as shown in FIGS. 7-9. The peripheral support member 138 is formed complementary to and fixed to the peripheral flange 15 of the lid member 114. Each of the right and left reinforcing members 32R and 32L is non-moveably attached (i.e., fixed) to the peripheral support member 138, such as by welding, riveting or with threaded fasteners, e.g., bolts and nuts. Moreover, each of the right and left reinforcing members 32R and 32L according to the second exemplary embodiment is made of sheet steel having thickness of about 1 mm.

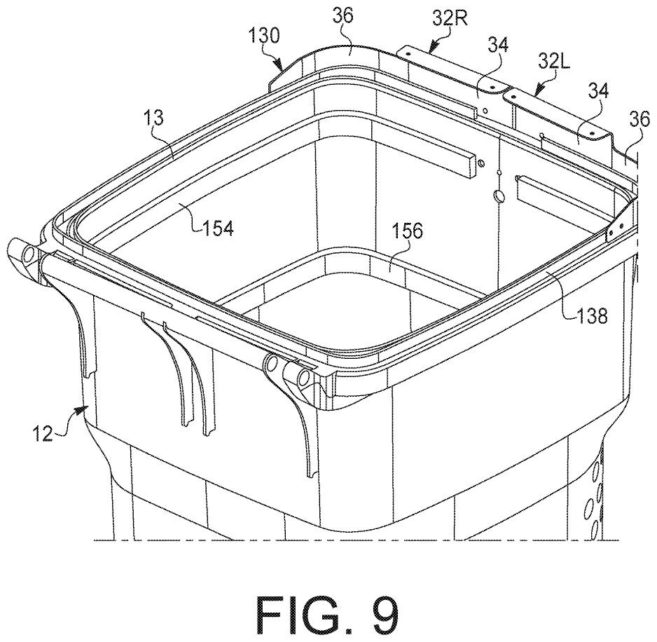

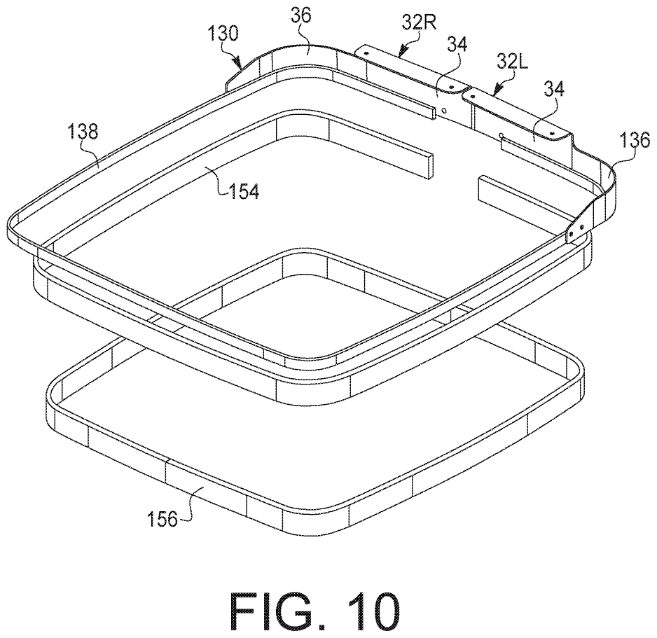

The residential dumpster 110 additionally or alternatively includes peripheral body support members 154 and 156, each secured (e.g., fixed) to an inner surface of container body member 12, as shown in FIGS. 9 and 10. Moreover, as illustrated in FIG. 9, each of the peripheral body support members 154 and 156 is formed complementary to the inner surface of the container body member 12. Each of the body support members 154 and 156 is non-moveably attached (i.e., fixed) to an internal surface of the container body member 12, such as by riveting or with threaded fasteners, e.g., bolts and nuts. The peripheral body support members 154 and 156 of the container body member 12 are made of lightweight and stiff material, such as steel tubing or sheet metal. Moreover, as illustrated in FIGS. 9 and 10, the peripheral body support member 154 is in the form of a split ring to provide a space for a residential dumpster latch.

The body support members 154, 156 are vertically spaced within body portion 12 remote from peripheral support member 138. Thus, the container body member 12 is structurally reinforced from the top downwardly, in order to withstand the weight of heavy objects, such as bears, when the dumpster 110 is tipped horizontally on its side. Also, according to the exemplary embodiment, the two body support member 154, 156 are spaced along the interior of the container body member 12, a greater or fewer number of the body support member may be utilized.

Those skilled in the art will recognize that the lid reinforcement of the first embodiment may be incorporated into and be combined with the body support reinforcement of the second embodiment illustrated in FIGS. 7-10.

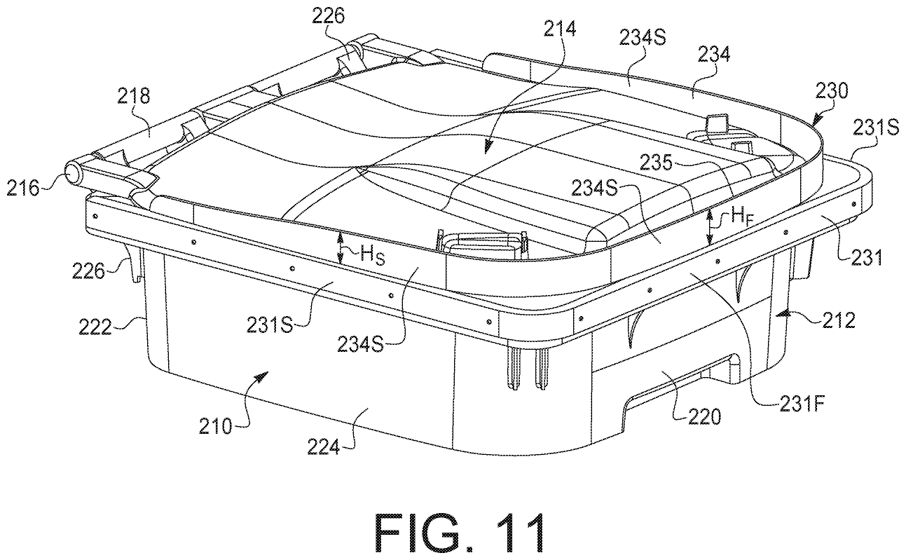

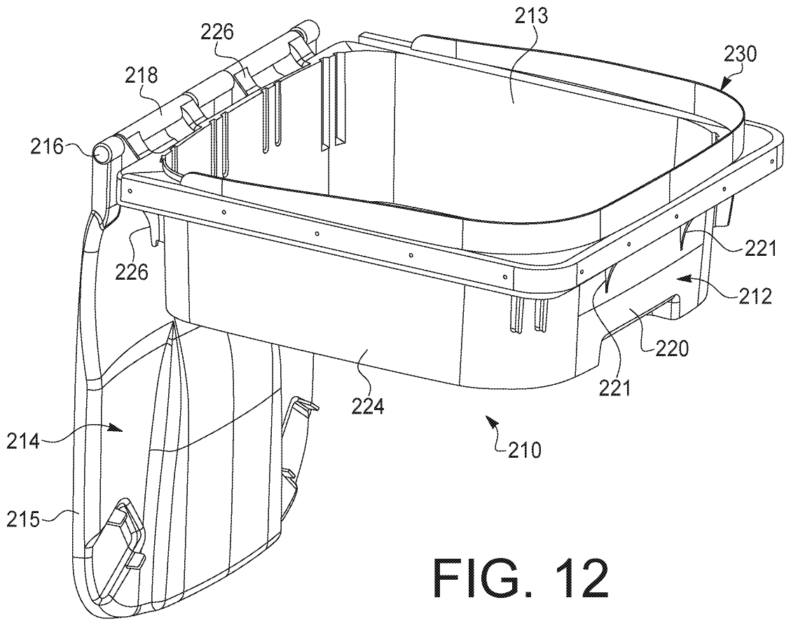

FIGS. 11 and 12 show a trash container (or residential dumpster, or roll-out cart) 210 according to an exemplary embodiment of the present invention. The container 210, such as a roll-out cart, is designed to be animal resistant, including to bears and other large and small animals. The container 210 comprises a hollow body member (or container body member) 212 (partially shown in a cut-away view in FIGS. 11-13) and a lid member 214 that is pivotally (hingedly) attached to a rear side of the body member 212 by a hinge pin 216. According to the exemplary embodiment, both the container body member 212 and the lid member 214 of the container 210 are made of suitable plastic material, such as polyethylene, that is tough, light-weight and strong; although other materials are also contemplated herein. Metal, such as steel or aluminum alloy, may also provide a lid protection device for container 210. The hollow body member 212 and the lid member 214 may be made by injection molding or rotational molding. The lid member 214 is pivotally mounted on the hinge pin 16, typically at a rearward portion of the container 210, so that when an upward force is applied to a distal end of the lid member 214, the lid member 214 opens by pivoting about the hinge pin 216.

The hollow body member 212 has a closed bottom and an open top edge 213 fitted to the lid member 214, which can be manipulated between an open position to access the trash container 210 and a closed position to close the open top edge 213 of the container body member 212 and restrict access to the container 210. The container 210 is usually rectangular or cylindrical in shape, however the shape may be dictated by methods of manufacture, economics or aesthetics. As best shown in FIGS. 1-3, the body member 12 includes an upper horizontal support portion 25 configured to support the lid member 14 in the closed position thereof. It will be appreciated that any other containers with removable or pivotable lids, such as dumpsters, are within the scope of the present invention.

According to the exemplary embodiment, the hollow body member 212 of the container 210 includes a bottom wall (not shown) closing a bottom of the container 210, a front wall 220, a rear wall 222 disposed opposite to the front wall 220, and opposite side walls 224 extending upwardly from the bottom wall to define a dumpster interior, as well known in the art. In other words, the opposite right and left walls 224 interconnect the opposite front wall 220 and the rear wall 222, as best shown in FIGS. 11 and 12.

A handle 218 extends from an upper end of the rear wall 222, such that the container 210 can be tipped back onto wheels and pulled by the handle 218. The handle 218, which may be used to pull the container 210, is mounted over the hinge pin 216 and secured to handle supports 226, as best shown in FIGS. 11 and 12.

The container 10 includes a lid protection device 230 fixed (i.e., non-moveably attached) to the top edge 213 of the container body member 212. The lid protection device 230 according to the exemplary embodiment includes a U-shaped guard frame (or guard rail) 231 and a U-shaped guard plate 234. The U-shaped guard plate 234 is fixed (i.e., non-moveably connected) to the U-shaped guard frame 231 so that the guard plate 234 projects upward from the guard frame 231 and is disposed adjacent to and outside an outer peripheral flange 215 of the lid member 214 in the closed position thereof, as best shown in FIG. 1, and to the top edge 213 of the body member 212, as best shown in FIG. 12. Moreover, the guard plate 34 is shaped complementary to the outer peripheral flange 215 of the lid member 214. In addition, a top edge 235 of the guard plate 234 extends over the lid member 214 in the closed position thereof, particularly over the outer peripheral flange 15 of the lid member 214, as best shown in FIG. 11.

As further shown in FIGS. 11-13, the guard rail 231 includes a front portion 231F extending horizontally along the front wall 220 of the container 210, and two side portions (protection members) 231S extending horizontally along the opposite side walls 224 of the container 210. Similarly, as also shown in FIGS. 11-13, the guard plate 234 includes a front straight plate (or portion) 234F extending horizontally along the front wall 220 of the container 210, two integral curved angle plates 236 integrally formed on horizontally opposite ends of the front straight plate 234F, and two side plates 234S extending horizontally along the opposite side walls 224 of the container 210. The front straight plate 234F has a height H_{F}, which is bigger than the height H_{S} of the side plates 234S, as illustrated in FIG. 11.

In the closed position, i.e., when the lid member 214 is in the down position, the lid protection device 230 and, more particularly, the guard frame 231 and guard plate 234 projecting upward from the guard frame 231 will not interfere with the lid member 214. The lid member 214 will fit within the space provided within the guard plate 234 such that the guard plate 234 will surround the perimeter (on three sides) the lid member 214. The guard plate 234 will also prevent the lid member 214 from being lifted upwards, e.g., opened, by an edge of the lid member 214 (as it is now protected by the guard plate 234) thus effectively preventing wild animals from opening of the lid member 214.

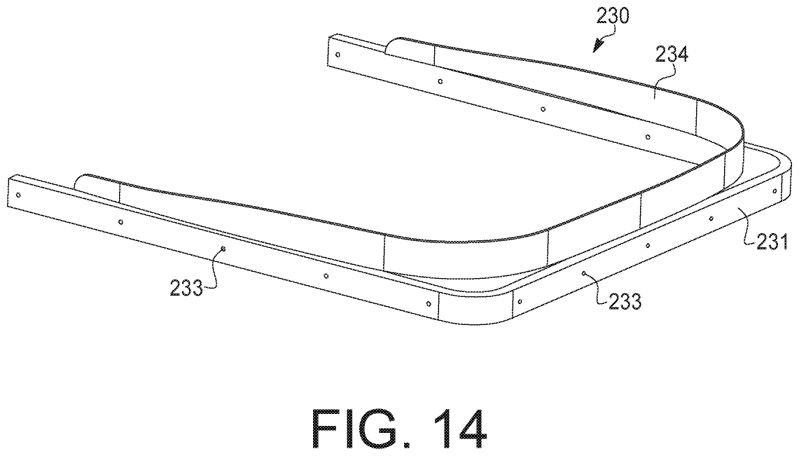

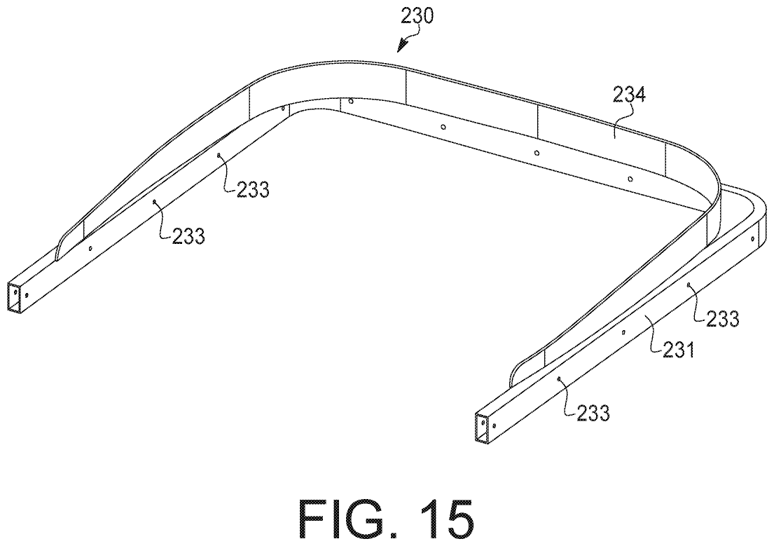

According to the exemplary embodiment, as shown in FIGS. 11, 12, 14 and 15, the guard frame 231 is a hollow U-shaped member, non-moveably attached (i.e., fixed) to the top edge the outer peripheral flange 215 of the lid member 214 of the hollow body member 212, such as by adhesive bonding, riveting or with threaded fasteners, e.g., bolts and nuts or threaded fasteners extending through holes 233 in the guard rail 231. Moreover, the guard plate 234 is a U-shaped member, non-moveably attached (i.e., fixed), such as by welding, adhesive bonding or mechanical fasteners (rivets, bolts and nut connection, etc.) to the guard frame 231 so as to be disposed adjacent and complementary to the outer peripheral flange 215 of the lid member 214 in the closed position thereof, as best shown in FIG. 11. Moreover, the lid protection device 230 according to the third exemplary embodiment is made of metal, such as steel or aluminum alloy. Specifically, the guard rail 231 is hollow and rectangular in cross-section, while the guard plate 234 is preferably made of a sheet of metal, as best shown in FIGS. 14 and 15.

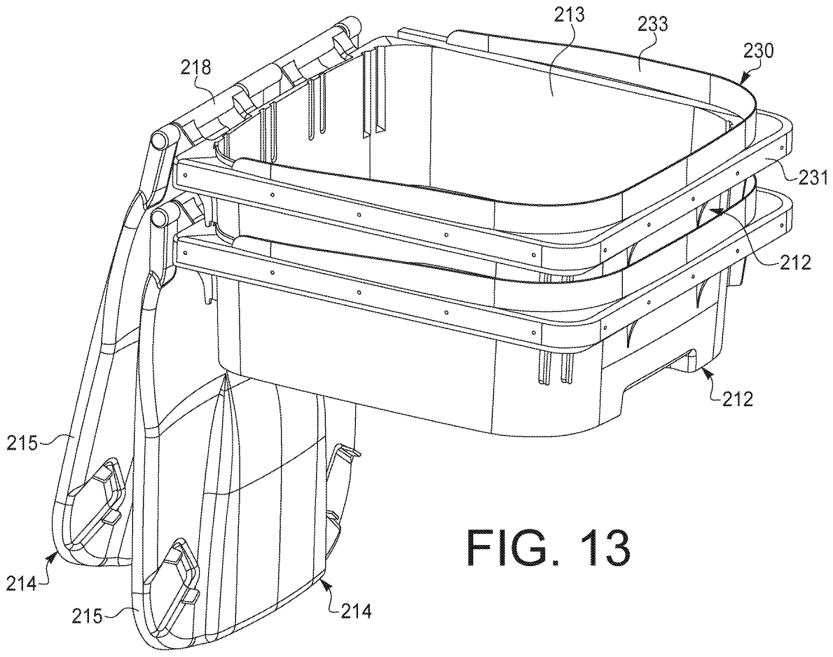

The advantage of the lid protection device 230 is to allow the containers to be nested together as shown in FIG. 13. The lid protection device 230 and, more particularly, the guard frame 231 and guard plate 234 are configured and shaped to allow the containers to be nested. That is, the lid protection device 230 and, more particularly, the guard frame 231 and guard plate 234 will not prevent one container body member 212 from being placed within another container body.

Previously, a frame was placed on the lids and when the containers were nested together, the lids could not flip over completely in the open position. As one of skill in the art would readily understand, the more containers that are nested together, the more lids need to be open and, hence, are in the open position. The thickness of the frame on the lid would interfere with the opening of many lids when the container are stacked together, thus prevented multiple containers to be stacked and packaged in a compact format.

Additionally, when the containers are stacked, they are then shrink wrapped for transport. When the lid protection devices are on the lid members, the lid members are not able to deform due to the rigidity of the lid protection devices, and the shrink wrap was not able to hold many of the containers together. As the lid protection device is now on the residential dumpster, the lids remain deformable and they are able to be shrunk wrap and squeezed against the back wall of the residential dumpster, thus saving a tremendous amount of space.

Thus, the containers 210 provide convenient nesting during shipping and storage thereof. Specifically, the body members 212 of the containers 210 are nestable together (i.e., inside each other) when the lid members 214 thereof are in the open position. Also, when the containers 210 are nested together for transportation or storage, as best shown in FIG. 13, the lid members 214 thereof are shrink wrapped together.

Also, the lid protection device 230 prevents damage of the plastic container 210 if accidentally knocked down by wind, animals or people. Particularly, the guard frame 231 reinforces the top edge 213 of the body member 212 so as to prevent the deformation of the top edge 213 of the body member 212, thus preventing opening of the lid member 214 so as to keep the container 210 in the closed position. Moreover, the guard plate 234 of the lid protection device 230 prevents animals from grabbing and lifting the lid member 214 in the closed position.

The other advantage is that since the weight of the frames are now on the container itself, the container will not be back weighted when the lids are open and the container stays more stable.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A residential dumpster comprising:
a hollow container body member having a side wall defining an open top edge, the side wall including a front wall, a rear wall opposite the front wall, a right wall connecting the front wall and the rear wall, and a left wall opposite the right wall and connecting the front wall and the rear wall;
a lid member pivotally attached to the rear wall of the container body member and pivotable between an open position and a closed position over the open top edge of the container body member, the lid member having an outer peripheral flange; and
a lid protection device including at least one lid protection member fixed to the outer peripheral flange of the lid member or to the container body member adjacent to the open top edge of the container body member, the at least one lid protection member including a front straight plate and an integral curved angle plate.

2. The residential dumpster as defined in claim 1, wherein the lid protection device includes right and left lid protection members formed separately and spaced from each other, wherein each of the right and left lid protection members is a unitary component and comprises a front straight plate and an integral curved angle plate, and wherein each of the right and left reinforcing members is non-moveably attached to the peripheral flange of the lid member.

3. The residential dumpster as defined in claim 2, wherein each of the right and left lid protection members further comprises a first side protection member non-moveably attached to the peripheral flange on one side of the lid member.

4. The residential dumpster as defined in claim 3, wherein the first side protection member includes an outer plate adjacent to an outer surface of one of the peripheral flange of the lid member, an inner plate adjacent to an inner surface of one of the side walls of the hollow container body member, and a connecting plate linking the outer and inner plates, of the first side protection member and supported by the top edge of the hollow body portion when the lid member in the closed position, and wherein the an outer plate is non-moveably attached to the peripheral flange on one side of the lid member.

5. The residential dumpster as defined in claim 4, wherein the lid protection device further includes a top reinforcing structure mounted to each of the first side protection member, wherein the top reinforcing structure includes at least one arched transverse lid support members each having opposite transverse ends, and wherein the at least one arched transverse lid support members is non-moveably attached to the lid member.

6. The residential dumpster as defined in claim 5, wherein the top reinforcing structure further includes two longitudinally extending opposite support bars, wherein each of the opposite transverse ends of the at least one transverse lid support members is fixed to one of the longitudinally extending opposite support bars, and wherein each of the longitudinally extending support bars is fixed to the inner plate of the first side reinforcing member.

7. The residential dumpster as defined in claim 3, wherein each of the right and left lid protection members further comprises a second side protection member non-moveably attached to the peripheral flange on one side of the lid member adjacent to the first side protection member.

8. The residential dumpster as defined in claim 7, wherein the second side protection member includes an outer plate adjacent to an outer surface of one of the peripheral flange of the lid member, an inner plate adjacent to an inner surface of one of the side walls 24 of the hollow container body member, and a connecting plate linking the outer and inner plates of the second side protection member and supported by the top edge of the hollow body portion when the lid member in the closed position, and wherein the an outer plate is non-moveably attached to the peripheral flange on one side of the lid member.

9. The residential dumpster as defined in claim 8, wherein the lid protection device further includes a top reinforcing structure mounted to each of the second side protection member, wherein the top reinforcing structure includes at least one arched transverse lid support members each having opposite transverse ends, and wherein the at least one arched transverse lid support members is non-moveably attached to the lid member.

10. The residential dumpster as defined in claim 9, wherein the top reinforcing structure further includes two longitudinally extending opposite support bars, wherein each of the opposite transverse ends of the at least one transverse lid support members is fixed to one of the longitudinally extending opposite support bars, and wherein each of the longitudinally extending support bars is fixed to the inner plate of the second side reinforcing member.

11. The residential dumpster as defined in claim 10, wherein the top reinforcing structure further includes at least two or more longitudinal lid support members each having opposite longitudinal ends, and wherein one of the opposite longitudinal ends of each of the longitudinal lid support members is fixed to one of the transverse lid support members.

12. The residential dumpster as defined in claim 11, wherein the top reinforcing structure further includes a transverse reinforcing bar extending between the longitudinal lid support members, and wherein the transverse reinforcing bar is secured to the longitudinal lid support members.

13. The residential dumpster as defined in claim 2, wherein the lid protection device further includes a peripheral support member formed complementary to and fixed to the peripheral flange of the lid member, and wherein the peripheral support member is non-moveably attached to the left lid protection members.

14. The residential dumpster as defined in claim 2, further comprising at least one peripheral body support member secured to an inner surface of the container body member, and wherein the at least one peripheral body support member is formed complementary to the inner surface of the container body member.

15. The residential dumpster as defined in claim 1, wherein the lid protection device 30 includes a U-shaped guard frame 231 fixed to the container body member 12 adjacent to the open top edge 13 of the container body member 212, and a U-shaped guard plate 234 non-moveably secured to the guard frame 231 so as to project upward from the guard frame 231 and dispose adjacent to the outer peripheral flange 15 of the lid member 14 in the closed position thereof.

16. The residential dumpster as defined in claim 15, wherein the guard plate 234 includes a front straight plate 234F extending horizontally along the front wall 220 of the container 210, two curved angle plates 236 integrally formed on horizontally opposite ends of the front straight plate 234F, and two side protection members 231S extending horizontally along the opposite side walls 224 of the residential dumpster 210.

17. The residential dumpster as defined in claim 15, wherein the lid member 14 is disposed within and below a top edge 235 of the guard plate 234 of the lid protection device 230 when the lid member 14 is in the closed position.

18. A method for assembling a residential dumpster, comprising the steps of:
providing a hollow container body member having a side wall defining an open top edge and a lid member, the side wall including a front wall, a rear wall opposite the front wall, a right wall connecting the front wall and the rear wall, and a left wall opposite the right wall and connecting the front wall and the rear wall;
pivotally attaching the lid member to the rear wall of the container body member so that the lid member is pivotable between an open position and a closed position of the container body member, the lid member having an outer peripheral flange;
providing a lid protection device including at least one lid protection member, the at least one lid protection member including a front straight plate 34 and an integral curved angle plate; and
non-moveably attaching the at least one lid protection member to the outer peripheral flange of the lid member or to the container body member adjacent to the open top edge of the container body member.

19. The method as defined in claim 18, wherein the step of providing the lid protection device includes providing right and left lid protection members formed separately and spaced from each other, wherein each of the right and left lid protection members is a unitary component and comprises a front straight plate and an integral curved angle plate, and wherein the step of non-moveably attaching the at least one lid protection member includes non-moveably attaching each of the right and left reinforcing members to the peripheral flange of the lid member.

20. The method as defined in claim 18, wherein the step of providing the lid protection device including a U-shaped guard frame and a U-shaped guard plate; and wherein the step of non-moveably attaching the at least one lid protection member includes non-moveably securing the U-shaped guard frame to the container body member adjacent to the open top edge of the container body member, and non-moveably attaching the U-shaped guard plate to the guard frame so as to project upward from the guard frame and dispose adjacent to the outer peripheral flange of the lid member in the closed position thereof.
